(19) United States
(12) Patent Application Publication
(10) Pub. No.: US 2005/0185691 A1
(43) Pub. Date: Aug. 25, 2005

(54) Coherent beam combination

(76) Inventor: Richard C. Slater, Waban, MA (US)

Correspondence Address: Lesley A. Hamlin;Textron Systems Corporation, 201 Lowell Street, Wilmington, MA, 01887, US

(21) Appl. No.: 10/622,403

(22) Filed: Jul. 18, 2003

(51) Int. Cl. H01S 3/08

(52) U.S. Cl. 372/95; 372/70; 372/66

(57) ABSTRACT

Systems and methods are disclosed for coherent combination of beams or waves from two or more gain media. The gain media may be arranged in an unstable resonator having a magnification factor. The output beams or waves from the gain media are expanded within the resonator due to the magnification of the unstable resonator and are combined coherently. The gain media may be laser media producing an output by stimulated emission or the gain media may be parametric gain media producing one or more outputs by parametric or three-wave interaction. A heat-conducting element may be in contact with and remove heat from the gain media.

### BACKGROUND

Coherent light has become a useful tool for many applications, particularly since the invention of the laser. Coherent light may be produced at practically any desired wavelength by the wavelength conversion of laser light by optical parametric devices and three-wave interaction. Many industries utilize lasers as sources of coherent light. For example, lasers are used, with and without parametric devices, in industrial manufacturing for various processes including cutting, machining and welding of metallic and non-metallic materials. Lasers are also used in the telecommunications industry to generate and amplify light transmitted over optical fibers.

To increase the power or energy output of a laser or optical parametric device, the size or volume of the gain media used in such a device can be increased within certain limits. These limits may vary according to the type of gain medium that is used. For example, in lasers having solid state gain media, the size of the gain medium may be limited by material properties and/or fabrication techniques. Similarly, fabrication and material properties may also limit the physical size of nonlinear or parametric gain media such as optical nonlinear crystals and crystalline materials. The power and energy scalability of solid state lasers and optical parametric devices may consequently be constrained by crystal growth and fabrication techniques.

As an alternative to increasing the volume of the gain media of individual lasers or parametric devices, attempts have been made to combine the coherent outputs from two or more of such devices. It is known in the art that in order to coherently combine two or more electromagnetic fields, e.g., laser outputs, the electromagnetic fields must be in-phase with one another. Information related to attempts to coherently combine multiple laser beams may be found in U.S. Pat. No. 5,936,993 and U.S. Pat. Pub. No. US2002/0172253. These methods and systems disclosed in these publications suffer from the requirement for adaptive optics and/or wave guide structures to be used to combine the laser beams. Such additional structures increase the size, complexity, and cost of the systems they are used with.

What is needed therefore are simple and inexpensive methods and systems to scale coherent outputs of lasers and optical parametric devices to higher power and output pulse energy.

### SUMMARY

Briefly, and in general terms, the present invention includes simple and inexpensive systems and methods that coherently combine output beams or electromagnetic fields of two or more gain media. The systems and methods disclosed include use of an unstable resonator. The gain media may be laser gain media or parametric gain media.

A first embodiment may include a system for coherent beam combination including an unstable resonator and at least two gain media located within the unstable resonator. A first electromagnetic field produced by a first gain medium of the at least two gain media propagates through a portion of a second gain medium of the at least two gain media after one or more roundtrips within the unstable resonator. The first electromagnetic field is in-phase with a second electromagnetic field produced by the second gain medium.

An output beam may be produced and the output beam may be proportional to an amplitude product squared, the amplitude product being the product of an amplitude of the first electromagnetic field multiplied by an amplitude of the second electromagnetic field. The gain media may be parametric gain media or laser gain media. The gain media may be configured in an array. A heat-conducting element may be in contact with the gain media to remove heat.

A second embodiment may include a method for coherent beam combination. A first electromagnetic field may be produced from a first gain medium and a second electromagnetic field may be produced from a second gain medium. The first and said second electromagnetic fields may be expanded in an unstable resonator having a magnification factor. The expanded first and second electromagnetic fields may be coherently combined.

An output beam may be produced with an intensity that is proportional to an amplitude product squared, with the amplitude product being the product of an amplitude of the first electromagnetic field multiplied by an amplitude of the second electromagnetic field. The step of producing the first or second electromagnetic fields may include producing signal and idler fields. A third electromagnetic field may be produced and expanded in the unstable resonator and combined with the first and second electromagnetic fields.

### BRIEF DESCRIPTION OF THE DRAWINGS

These and other features, aspects, and advantages of the present invention will become better understood with regard to the following description, appended claims, and accompanying drawings. The drawings are not necessarily to scale, emphasis instead being placed upon illustrating the principles of the present invention. The drawings include the following:

FIG. 1 is a simplified diagram that shows parts of a coherent beam combination system.

FIG. 2 is a cross section view of the coherent beam combination system of FIG. 1 taken along line 2-2.

FIG. 3 is a simplified diagram of an alternate embodiment of a coherent beam combination system.

FIG. 4 is a cross section view of the coherent beam combination system of FIG. 3 taken along line 4-4.

FIG. 5 is a simplified diagram of an alternate embodiment of a coherent beam combination system.

FIG. 6 is a cross section view of the coherent beam combination system of FIG. 5 taken along line 6-6.

FIG. 7 is a flow chart of a method of coherently combining the outputs from multiple gain media.

### DETAILED DESCRIPTION

The present invention may be understood by the following detailed description, which should be read in conjunction with the attached drawings. The following detailed description is by way of example only and is not meant to limit the scope of the present invention.

The present invention is directed to systems and methods that coherently combine beams or electromagnetic fields produced by separate gain media or crystals. Multiple gain media may be positioned within an unstable resonator having a magnification factor. Due to the magnification factor, an output field or wave from one gain medium may expand and overlap other gain media within the unstable resonator. The overlapped fields or waves may be in-phase and combined coherently within the resonator to form a field with higher power and energy than could be obtained with a single, sized-limited gain medium. The resulting field may be outcoupled or transmitted from the unstable resonator as an output beam that has an intensity that is proportional to the square of the coherent combination of the amplitude fields within the resonator, i.e., proportional to the squared product of the amplitudes of the overlapped fields within the resonator.

Unstable optical resonators may be used in embodiments of the present invention. So-called “unstable” resonators are referenced as such because of the instability of the resonant modes within such resonators. Unstable resonators are characterized by an inherent telescopic magnification or magnification factor M. The cross-sectional size of optical modes formed in unstable resonators continually grows by a factor, e.g., M², on each roundtrip through the resonator.

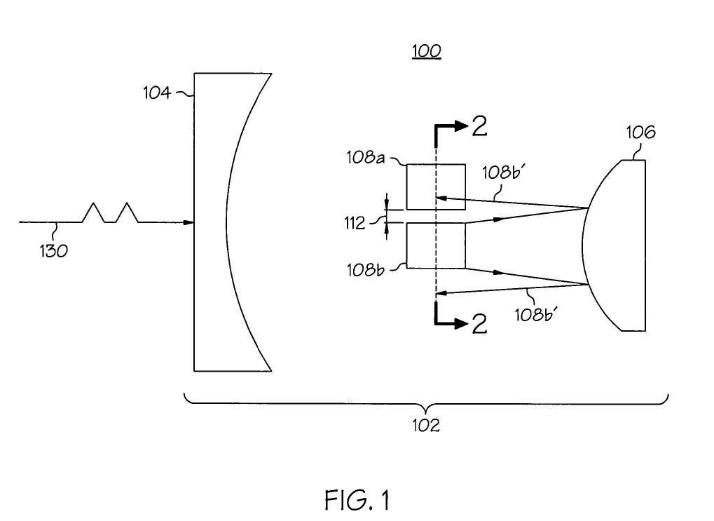

With reference to FIGS. 1-7, embodiments of the present invention will now be described. FIG. 1 is a simplified diagram that shows parts of a coherent beam combination system 100. The system 100 may include an unstable resonator 102 having a magnification factor M, and the unstable resonator 102 may include a first mirror 104 and a second mirror 106. Multiple gain media 108a and 108b are present within the unstable resonator 102 and are pumped by appropriate apparatus (omitted for the sake of clarity). A pump wave 130 is shown incident on the first mirror 104. The pump wave 130 may be a continuous wave (CW), a quasi-CW, or a pulsed wave, as shown. Mirror 104 is configured as an output coupler.

A suitable unstable resonator, e.g., 102, may be selected for use by appropriate design of the stability of the resonator. The stability of a resonator is often graphically represented by a hyperbola having coordinate axes that consist of stability parameters, sometime referred to as the “g-parameters.” For a two-mirror resonator, the g-parameters have the following form:
g₁=1+(d/R₁); (1)
g₂=1+(d/R₂); (2)
where d is the length of the optical axis within the resonator, and R₁ and R₂ each represent a radius of curvature for one of the resonator mirrors, respectively. The stability condition is described by the following:
0≦g₁g₂≦1; (3)
Resonator geometries corresponding to points within the hyperbola described by Eq. (3) are stable while those outside of the hyperbola are unstable. Where the product of g₁ and g₂ is a positive value, an unstable resonator is said to be a “positive-branch” unstable resonator. Similarly, where the product of g₁ and g₂ is a negative value, an unstable resonator is said to be a “negative-branch” unstable resonator.

Within the unstable resonator 102, resonant modes formed from outputs or fields, e.g., 108b′, of each of the gain media grow or expand along the length of the resonator 102 due to the magnification effect of the resonator 102. More specifically, during each roundtrip through the unstable resonator 102, the cross-sectional area of the modes grow or expand by a factor approximately equal to square of the resonator magnification factor, i.e., M². The expansion of the modes causes the output or field from one gain medium to overlap an adjacent gain medium or gain media. For example, after magnification by the unstable resonator 102, output 108b′ will overlap gain medium 108a as shown. While not shown, it should be understood that a similar output exists for gain medium 108a.

The outputs of the gain media may consequently be coherently combined and outcoupled as a single output beam 140 that may have more power or fluence than a beam produced by a size-limited gain medium. The output beam 140 may be highly coherent and the degree of coherence may depend on factors such as the amplifier or gain bandwidth of the gain media and the filtering effect of the resonator mirrors. The resulting modes that are supported by resonator 102 include fields that are amplified by the gain media, which fields may be in-phase with one another, and thus coherent, without the need for any adaptive optics such as deformable mirrors.

The coherent combination of the outputs or fields within the unstable resonator 102 may be enhanced by minimization of any optical path length differences through the respective gain media. Such minimization may be accomplished by, for example, appropriate design of the unstable resonator and gain media geometries. In certain embodiments, the geometric design of the unstable resonator 102 and the placement of the gain media within the resonator 102 may be such that the total optical path length is the same or nearly the same for all output rays, regardless of the gain medium of origin.

Regarding the configuration of the gain media 108a and 108b, each may be placed in a plane that is transverse to the longitudinal axis or optical axis of the unstable resonator 102. Furthermore, each gain medium may be positioned an equal distance away from and on a different side of the longitudinal axis of the resonator 102.

In certain embodiments, the gain media 108a and 108b may be placed at or near the midpoint of the distance between the first 104 and second 106 mirrors of the resonator 102, i.e., near the midpoint of the length of the unstable resonator 102. A gap or separation distance 112 separates the gain media 108a and 108b, which may be positioned using known apparatus, such an optical bench or the like.

In certain embodiments, the separation distance 112 may be on the order of one-millimeter. In certain embodiments, the gain media 108a and 108b may be shaped as identical, rectangular prisms. The gain media 108a and 108b may be orientated such that the long axis of each is parallel to the longitudinal axis of the unstable resonator 102. Each gain medium may also have the same nominal gain length as the other and may be made of the same material, e.g., potassium titanyl phosphate (KTiOPO₄ or “KTP”).

Any suitable unstable resonator design may be used for the unstable resonator 102, e.g., a positive-branch unstable resonator. The unstable resonator 102 may be a confocal unstable resonator in certain embodiments. Suitable confocal unstable resonator designs include confocal-planar and confocal-convex types. In certain embodiments, the mirrors used in the unstable resonator as output couplers, e.g., 104, may be implemented with a graded reflectivity profile, such as a substantially guassian or super-guassian profile, to improve the characteristics of the output beam. Such output couplers, or graded-reflectivity mirrors, may include a high reflectivity central region known as a dot reflector. An apodizing or smoothing element may be used to limit the output beam diameter.

The materials used for the gain media 108a and 108b may be active or “laser” gain media or may be optical parametric gain media. Suitable types of laser gain media may include gas, liquid, or solid state media including semiconductor gain media. Suitable example of such media include but are not limited to chromium-doped colquiriite crystals including lithium strontium aluminum fluoride (LiSAF), lithium strontium gallium fluoride (LiSGaF), and lithium calcium aluminum fluoride (LiCAF). Cerium-doped lithium strontium aluminum fluoride (Ce:LiSAF), chromium-doped ruby or titanium-doped sapphire (Ti:sapphire) laser media may be used as gain media in certain embodiments. Yttrium aluminum garnet (YAG) or yttrium lithium fluoride (YLF) doped with trivalent laser activator ions from both the Rare Earth and Transition Metal groups, e.g., neodymium (Nd), chromium (Cr), erbium (Er), and ytterbium (Yb) may be used as gain media in certain other embodiments.

The gain media may include semiconductor materials and laser diode structures. Suitable semiconductor materials include any direct-gap semiconductor material. Materials from the aluminum gallium arsenide (AlGaAs), indium gallium arsenide (InGaAs) and indium gallium arsenide phoshide (InGaAsP) alloy systems may be used. Suitable laser diode structures include but are not limited to homostructures, heterostructures and double-heterostructures. One or more quantum wells may be included within the diode laser structure. Quantum cascade (QC) lasers may be used as gain media in certain embodiments. For example QC lasers may be fabricated at any wavelength from approximately 4.5 to 17 microns using AlInAs/InGaAs lattices on indium phosphide (InP).

Embodiments of the present invention may utilize nonlinear optical crystalline materials or crystals as parametric gain media. Such nonlinear materials and crystals (“crystals”) may be used to produce optical parametric generation, in which three optical waves or fields are mixed and one or two of the three optical waves may be selectively amplified. By exploiting the nonlinear electric susceptibility of a nonlinear crystal, electromagnetic energy at one wavelength may be converted to another wavelength, provided that conditions of conservation of energy and momentum or phase are satisfied. Thus certain embodiments may function as an optical parametric oscillator (OPO).

Nonlinear optical (“nonlinear”) crystals are commonly characterized as certain parametric types, according to how the effect of double refraction or birefringence affects incident light once it enters the particular crystal. A nonlinear crystal may be referred to as a Type I crystal when an incident or “pump” wave is doubly refracted into signal and idler fields or waves that have the same polarization, which is orthogonal to the pump wave. A Type II nonlinear crystal is one producing orthogonally polarized signal and idler fields or waves from a pump wave. In certain embodiments, nonlinear crystals used as parametric gain media are of the same parametric type, i.e., Type I or Type II.

In certain embodiments, birefringent nonlinear crystals may be used as gain media. Suitable nonlinear crystals may include but are not limited to crystals of ammonium diphosphate (NH₄H₂PO₄ or “ADP”), beta (β) barium borate (BBO), gallium selenide (GaSe), barium lithium niobate (Ba₂LiNb₅O₁₅), cadmium gallium sulfide (CdGa₂S₄), cadmium selenide (CdSe), cadmium germanium diarsenide (CdGeAs₂), lithium niobate (LiNbO₃), stoichiometric lithium niobate (LiNbO₃), lithium tantalate (LiTaO₃), lithium triborate (LiB₃O₅ or “LBO”), potassium diphosphate (KH₂PO₄ or “KDP”), potassium titanyl phosphate (KTiOPO₄ or “KTP”), potassium titanyl arsenate (KTiOAsO₄ or “KTA”), indium doped potassium titanyl arsenate (In:KTiOAsO₄ or “In:KTA”), rubidium titanyl arsenate RbTiOAsO₄ (RTA), silver gallium selenide (AgGaS₂), silver gallium sulfide (AgGaS₂), silver arsenic sulfide (Ag₃AsS₃ or “proustite”), potassium niobate (KNbO₃), neodymium doped magnesium lithium niobate (Nd:MgLiNbO₃), and suitable chalcopyrites. Suitable nonlinear crystals may also be selected from the following compound systems or alloys: (Zn₁₋ₓCdₓ)GeAs₂, Zn(Ge₁₋ₓSiₓ)As₂, and Zn(Ge₁₋ₓSiₓ)P₂. Other suitable nonlinear crystals for the gain media may include alloys or compound systems of AgGa₁₋ₓInₓSe₂ and CdGe(As₁₋ₓPₓ)₂.

In addition to the materials described above, quasi-phase matching (QPM) or periodically poled nonlinear crystalline materials may be used as parametric gain media. Such QPM materials utilize periodic domain inversion, or periodic poling, and can be used to form a QPM grating that compensates for phase velocity mismatch between the interacting waves or signals. A change in the sign of the nonlinear coefficient accompanies the domain reversal and consequently such gratings can compensate for dispersion due to refractive index of the material. Periodically poled or QPM materials may allow for a combination of propagation direction and polarizations to be selected that exploit the largest nonlinear coefficient in a particular nonlinear crystalline material.

Suitable periodically poled materials for use as gain media may include, but are not limited to periodically poled lithium niobate (PPLN), periodically poled KTP (PPKTP), and periodically poled RTA (PPRTA). Periodically twinned gallium arsenide (PTGaAs) or other lithography-patterned materials may also be used for the gain media as a QPM material. Guided wave QPM materials, in which a QPM material is incorporated into a guided-wave structure such as an annealed-proton-exchanged LiNbO₃ structure, may also be used for the gain media. Aperiodically poled materials including but not limited to aperiodically poled lithium niobate (APPLN) may also be used for the gain media.

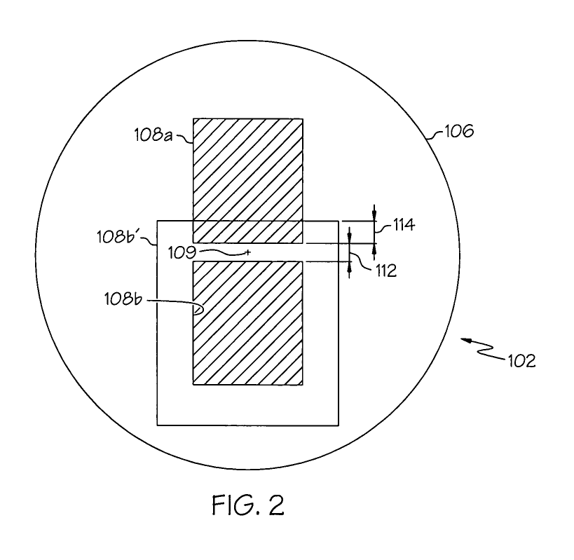

Referring now to FIG. 2, a cross section view is shown of the coherent beam combination system 100 of FIG. 1 taken along line 2-2. As previously described, due to the magnification effect of the unstable resonator 102, an output of one gain medium overlaps the adjacent gain medium as that output travels and grows within the resonator 102. For example, after magnification by the unstable resonator 102, an output produced by gain medium 108b, i.e., output 108b′, overlaps adjacent gain medium 108a by an overlap distance 114, as shown. The separation distance 112 and the magnification factor M of the unstable resonator 102 may be factors that influence the overlap distance 114.

In certain embodiments, the gain media 108a and 108b may have equal cross-sectional areas relative to the longitudinal axis 109 of the unstable resonator 102. The gain media 108a and 108b may have faces that are perpendicular to the longitudinal axis 109 and may also have peripheral faces that are parallel to the longitudinal axis 109. In certain embodiments the separation distance 112 between the gain media may be on the order of one to several millimeters. In certain other embodiments, the separation distance 112 may be on the order of tens or hundreds of microns.

For the geometry shown in FIG. 2, the coupling of the electromagnetic output field, e.g., signal or idler, from one gain medium to the other may be approximated by use of a simplified form of one of the Maxwell Equations. Using parametric generation or interaction as an example, the simplest form of the Maxwell Equation that describe phase-matched three wave parametric amplification in two side-by-side nonlinear crystals located in different regions of (x,y) space is given by the following equation:
∂Eⱼ/∂z=χⱼ(x,y)EₖEₗ*; (4)
where E_{j,k,l} are the electric field strengths of each of the three waves with j≠k≠l, * indicates the complex conjugate of a particular electric wave or field, and
χⱼ=(j)(d_{eff})(ωⱼ)/(c)(nⱼ); (5)
where d_{eff} is proportional to the crystal nonlinear susceptibility, ωⱼ is the frequency of the i^{th} wave with refractive index nⱼ and j, when not an index, is the square-root of negative one. Terms incorporating the refractive index of a particular nonlinear crystalline material can be combined with the nonlinear susceptibility and may be referred to as a nonlinear coefficient d_{NL} or d_{eff}.

In the case of parametric interaction, the indices j, k, l in Eq. (4) refer to the pump (p), signal (s), and idler (i) waves or fields, respectively. The boundary conditions for Eq. (4) that describe the value of the susceptibility within the unstable resonator 102 in a plane transverse to the optical axis and through the parametric crystals 108a and 108b, e.g., along section 2-2, are described the following equations:
χⱼ(x,y)=χⱼ for (x₁,y₁)≦(x,y)≦(x₂,y₂); (6)
χⱼ(x,y)=0 for (x₂,y₂)≦(x,y)≦(x₃,y₃); (7)
χⱼ(x,y)=χⱼ for (x₃,y₃)≦(x,y)≦(x₄,y₄); (8)

A useful approximate solution to the partial differential equation in Eq. (4) with boundary conditions of Eqs. (6)-(8) may be obtained by assuming that the field output, e.g., signal wave, from one parametric crystal is weakly coupled to the field of the other crystal. Weak coupling is indicated in the case of a low magnification resonator with M=1+x, where x<<1. The approximate solution may be obtained by a first order peturbation analysis. Using signal fields as an example, in the first step of this peturbation analysis, zeroth order signal output fields, Eₛ₁(0) and Eₛ₂(0), are computed using equation (4) for two uncoupled parametric amplifiers labeled 1 & 2, respectively. Next, a first order correction may be obtained by multiplying the zeroth order signal field strength of one amplifier, e.g., #1, by the factor (M−1). This expression models, in effect, the small overlap between the output fields.

An improved estimate of the weakly coupled problem may then be obtained by adding the first order correction to the zeroth order estimate for either amplifier. For example, the weakly coupled output field of parametric amplifier #2 is given by the following:
Eₛ₂(1)=Eₛ₂(0)+(M−1)(Eₛ₁(0)). (9)
There is an analogous expression for parametric amplifier #1 except that the factor in the first order correction term for Eₛ₁(1) is obtained by the conservation of power requirement:
(Eₛ₁(0)+Eₛ₂(0))²=(Eₛ₁(1)+Eₛ₂(1))²; (10)
Optical parametric oscillator performance is then modeled by outcoupling or transmitting a fraction (1−R), where R is the power reflectivity of the outcoupling mirror, of the signal power from each amplifier and reflecting the rest of the signal field, e.g., (R)^{0.5}(Es_{1 or 2}(1)), back into the input of each amplifier. Starting from signal noise, the resonator output may be modeled to reach a steady state value after a certain number of passes, e.g., ten to twenty, are made through each amplifier.

A computer program developed by the inventor has modeled and confirmed the coupling of two side-by-side parametric gain media of typical dimensions, e.g., 5 to 15 mm on a side, within an unstable resonator configured as shown in FIG. 2. The computer program was written in Compaq Visual Basic Version 6.5 and was tested to execute the OPO modal analysis. Uncoupled OPO cases were used as a starting point and used the exact analytical solutions described by Jacobi elliptical functions and complete elliptical solutions of the first kind. See, for example, G. T. Moore, et al., IEEE J. Of Quantum Electronics 31, 761 (1995), the contents of which are incorporated herein by reference.

The approach used to ascertain the OPO coupling effect took into consideration two parametric amplifiers with slightly different uncoupled gains, e.g., G(1)/G(2)=1.2, where G(1) and G(2) refer to the different amplifier gains. The effects on the OPO quantum yield of the side-by-side arrangement were determined as the coupling was increased from an initial value of zero. It is known that a maximum quantum yield for two side-by-side OPOs is 2.0, i.e., a factor of 1.0 per pump photon per OPO, in the non-degenerative case. Different gains will lead to distinctly different OPO thresholds, and the threshold difference will change as the OPOs couple together. As a practical matter, a gain ratio of 1.2 was found to correspond to a susceptibility ratio in nominally identical crystal samples of only 1.095, well within the measured crystal-to-crystal variability of susceptibility.

The modeling analysis performed by the inventor indicated that for a magnification factor M of values including 1.04 and 1.12, significant coupling occurs between side by side OPOs. Further analysis may be made to take explicit account of the transverse spatial overlap between the OPOs, parametric amplifiers or laser amplifiers. Such analysis may take into consideration the diffraction terms, e.g., ∂²E/∂x²+∂²E/∂y², that convert this quasi-one-dimensional problem to a three-dimensional problem. Software for resonator modeling may incorporate such diffraction terms that arise from side-by-side or array configurations. Such software may include functionality for numerical integration in z, the variable along the optical axis, and the transverse coordinates may be handled by Huygens-Fresnel diffraction integrals containing elements of the ABCD matrix, i.e., the combined ray-transfer matrix or set of matrices, that model cavity optics. Such software may directly calculate the resultant signal amplitude and phase front from a side-by-side OPO or laser arrangement.

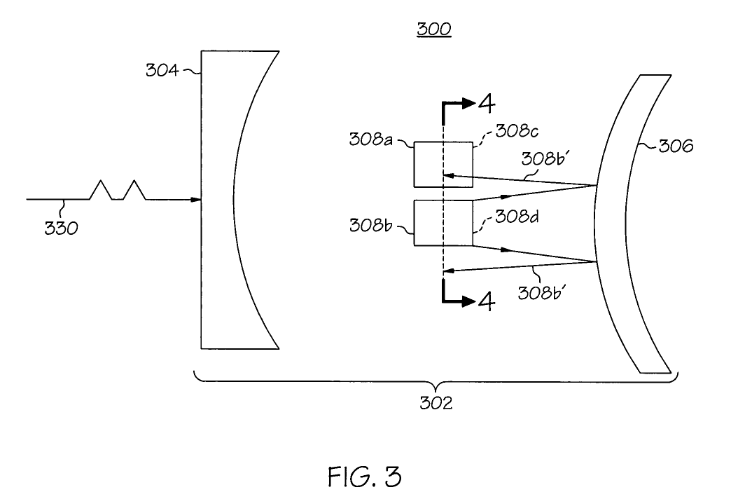

Referring now to FIG. 3, a simplified diagram is shown of an alternate embodiment 300 that includes an unstable resonator 302 and an array of gain media. An array of four gain media 308a-308d is positioned within the unstable resonator 302 and the individual gain media may be separated by separation distance 312. Unstable resonator 302 has a magnification factor M and includes a first mirror 304 and a second mirror 306. A pump wave 330 is shown incident on the first mirror 304. For each roundtrip across the unstable resonator 302, the outputs of the individual gain media expand by a factor that is proportional to square of the magnification factor, i.e., by M².

For example, output 308b′ is shown in FIG. 3 overlapping a portion of gain media 308a, where mirror 306 is configured as an output coupler. The gain media 308a-308d may be positioned at any suitable location along the longitudinal axis of the unstable resonator 302. The gain media 308a-308d may be arranged in a two-by-two array that is transverse to the longitudinal axis of the unstable resonator 302 as shown. The outputs of the gain media may consequently be coherently combined and outcoupled as a single beam 340.

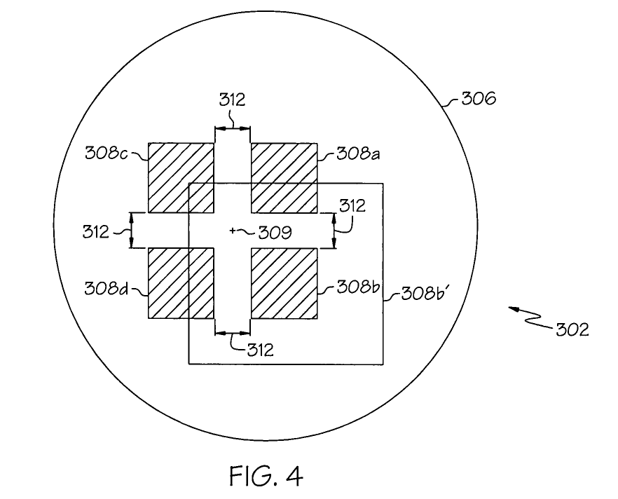

FIG. 4 is a cross section view of the coherent beam combination system 300 of FIG. 3 taken along line 4-4. The four gain media 308a-308d may be positioned in two-by-two (2×2) square array. The array may be centered about the longitudinal axis of the unstable resonator, as shown by the position of second mirror 306. An output 308b′ of gain media 308b is shown overlapping a portion of each of the other gain media 308b-308d. The separation distance 312 between each pair, e.g., 308a and 308c, of adjacent media may be equal or of different values. In alternate embodiments, the array may be in a four-by-one (4×1) configuration.

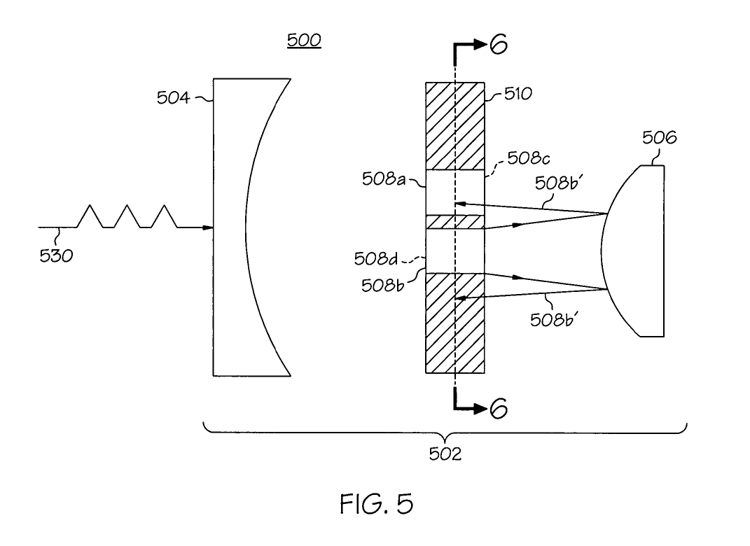

FIG. 5 is a simplified diagram of an alternate embodiment of a coherent beam combination system 500 that includes a heat-conducting element to remove heat produced by the gain media. An unstable resonator 502 includes a first mirror 504 and a second mirror 506, and the unstable resonator 502 may include multiple gain media 508a-508d, similar to the embodiment of FIG. 3 and FIG. 4. The gain media 508a-508d may contact a heat-conducting element 510 to facilitate the transfer of heat away from the gain media 508a-508d and to mitigate thermal effects on modes within the resonator 502.

For example, the gain media 508a-508d may be embedded or fit in holes or depressions in the heat-conducting element 510. In certain embodiments, the heat-conducting element 510 may contact peripheral faces of the gain media that are parallel to the longitudinal axis of the resonator. The heat-conducting element 510 may be made of diamond including optical quality diamond, amethyst, or any other suitable heat conducting material. In certain embodiments, the heat-conducting element 510 may be transparent to one or more wavelengths propagating within the unstable resonator 502. The outputs of the gain media may consequently be coherently combined and outcoupled as a single beam 540. Mirror 504 is configured as an output coupler.

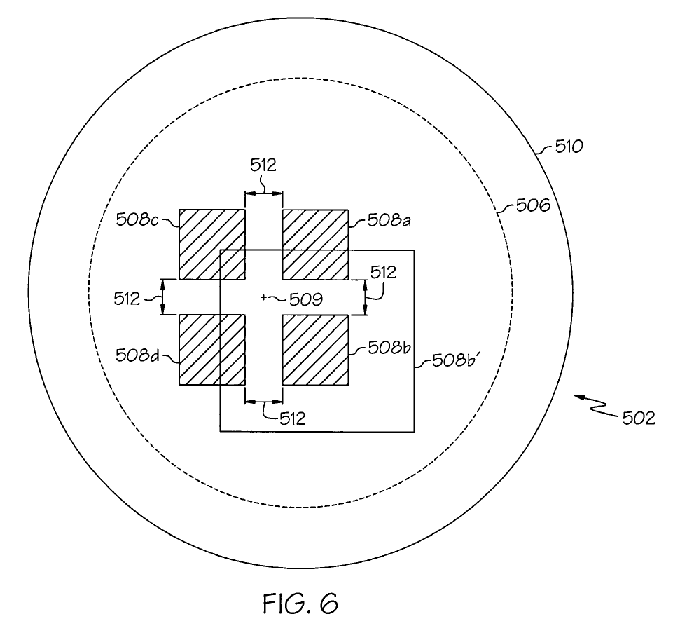

FIG. 6 is a cross section view of the coherent beam combination system of FIG. 5 taken along line 6-6. The multiple gain media 508a-508d may be arranged in a square array and may be within heat-conducting element 510. As the gain media 508a-508d produce heat, the heat may be conducted away from the gain media 508a-508d, thus helping to prevent thermal material breakdown of the gain media 508a-508d and thermal lensing effects. The separation distance 512 between each pair of adjacent gain media may be identical to minimize differences in optical path length of the various outputs. In certain embodiments, the separation distance 512 may vary between the gain media 508a-508d. In certain embodiments, the heat-conducting element 510 may be transparent to the light or electromagnetic output produced by or transmitted through the gain media 504a-504d.

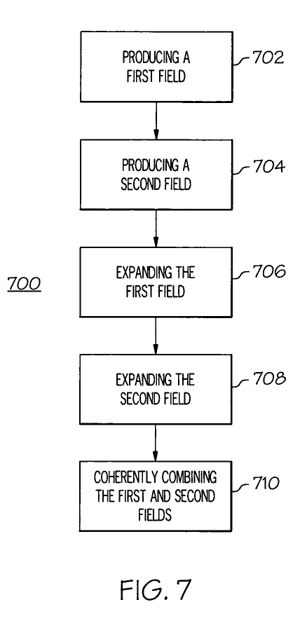

FIG. 7 a flow chart of a method 700 of coherently combining the outputs from multiple gain media. A first electromagnetic field may be produced 702 in a first gain medium such as a laser or a parametric gain medium. A second electromagnetic field may be produced 704 in a second gain medium such as a laser or a parametric gain medium. The first electromagnetic field may be expanded 706 in an unstable resonator by the magnification effect of the resonator. The second electromagnetic field may be expanded 708 in the unstable resonator in a similar manner. The first and second electromagnetic fields may be coherently combined 710 by the overlapping of the first electromagnetic field on the second gain medium and the second electromagnetic wave on the first gain medium. The resulting output may have higher power and fluence levels than a beam produced from a size-limited gain medium, and no adaptive optics are required.

With reference to the FIG. 1, use of an embodiment will now be described. To combine outputs and scale the power of gain media, multiple gain media, e.g., two optical parametric crystals 108a and 108b, may be placed in a side-by-side configuration within the unstable resonator 102 as shown. Suitable apparatus (not shown) for pumping, e.g., a diode array, provides a suitable pump wave 130 at or above the parametric threshold of the two parametric crystals 108a and 108b. After sufficient pump energy is provided to the gain media 108a and 108b, the output fields produced from the individual gain media are expanded to overlap the adjacent gain medium after reflection from one or both of the resonator mirrors, e.g., mirror 106, due to the magnification effect of the resonator 102.

The condition of field overlap may be facilitated by selection of the separation distance 112 between the gain media 108a and 108b and by design of the magnification factor M. Any desired value of M may be obtained by appropriate design of the geometry of the unstable resonator 102, e.g., by selecting mirrors having certain g-parameters as defined in Eqs. (1)-(3). The output fields of the gain media are coherently combined and outcoupled from the unstable resonator. The mirror reflectivities may be controlled to produce outcoupling after a desired number of passes, e.g., 10 or 20, through the unstable resonator 102.

Accordingly, embodiments of the present invention may scale lasers and optical parametric devices to higher power, fluence, and output pulse energy. Gain media that are the largest practical size according to fabrication techniques may be effectively coupled together by the coherent combination of their respective output fields. Embodiments may be used advantageously for laser cutting, machining and welding of metallic and non-metallic materials. Laser ablation and destruction of various structures and materials may also be realized with embodiments of the present invention.

Although the present invention has been described in detail with reference to certain versions thereof, other versions are possible. For example, while use of an unstable resonator with two mirrors or lenses has been described, unstable ring resonators having more than two mirrors may be used. Further, while optical parametric unstable oscillators have been described generally, such oscillators may be singly, doubly or triply resonant. Additionally, while the pump waves described above were incident along the longitudinal axis of the unstable resonators, pumping from off of the longitudinal axis or optical axis may be employed.

Furthermore, the separation distance between adjacent gain media is not limited to and may be different than the distances given above. Factors influencing the separation distance may include but are not limited to (1) the geometry of the unstable resonator including the magnification factor, (2) the heat produced by the gain media, and (3) the presence of a heat conducting element between the gain media. Further, gain media other than solid state gain media, e.g., gas or liquid dye media, may be used.

The reader's attention is directed to all papers and documents that are filed concurrently with this specification and which are open to public inspection with this specification, and the contents of all such papers and documents are incorporated herein by reference. All the features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalents or similar features.

1. A system for coherent beam combination comprising:
an unstable resonator;
at least two gain media located within said unstable resonator;
wherein a first electromagnetic field produced by a first gain medium of said at least two gain media propagates through a portion of a second gain medium of said at least two gain media after one or more roundtrips within said unstable resonator; wherein said first electromagnetic field is in-phase with a second electromagnetic field produced by said second gain medium.

2. The system of claim 1, further comprising an output beam exiting said unstable resonator.

3. The system of claim 3, wherein said output beam has an intensity proportional to an amplitude product squared, said amplitude product being an amplitude of said first electromagnetic field multiplied by an amplitude of said second electromagnetic field.

4. The system of claim 1, wherein said at least two gain media are laser gain media.

5. The system of claim 1, wherein said at least two gain media are parametric gain media.

6. The system of claim 1, wherein said separation distance is between about 100 microns to about five millimeters.

7. The system of claim 1, wherein said separation distance is about 1 millimeter.

8. The system of claim 1, further comprising a heat-conducting element in contact with said at least two gain media.

9. The system of claim 8, wherein said heat-conducting element lies in a plane transverse to a longitudinal axis of said unstable resonator.

10. The system of claim 9, wherein said heat-conducting element contacts portions of said at least two gain media that are parallel to said longitudinal axis.

11. The system of claim 8, wherein said heat-conducting element is made of diamond or amethyst.

12. The system of claim 11, wherein said diamond is optical quality diamond.

13. The system of claim 4, wherein said laser gain media are selected from the group consisting of Nd:YAG, Nd:YLF, Cr:LiSAF, Cr:LiSGAF, Cr:LiCAF, Ce:LiSAF, and Ti:Saphhire.

14. The system of claim 5, wherein said parametric gain media are quasi-phase-matched (QPM) nonlinear crystals.

15. The system of claim 5, wherein said parametric gain media are birefringent nonlinear crystals.

16. The system of claim 14, wherein said parametric gain media are selected from the group consisting of periodically twinned gallium arsenide (PTGaAs), periodically poled lithium niobate (PPLN), periodically poled KTP (PPKTP), periodically poled RTA (PPRTA).

17. The system of claim 15, wherein said parametric gain media are selected from the group consisting of ADP, BBO, GaSe, CdGa₂S₄, CdSe, CdGeAs₂, LiNbO₃, LiTaO₃, LBO, KDP, KTP, AgGaS₂, AgGaS₂, and proustite.

18. The system of claim 1, wherein said at least two gain media comprise four gain media.

19. The system of claim 18, wherein said four gain media are in a two-by-two array.

20. The system of claim 1, wherein said unstable resonator is a negative or positive-branch unstable resonator.

21. The system of claim 1, wherein said unstable resonator is a confocal unstable resonator.

22. The system of claim 21, wherein said confocal resonator is a confocal-planar or confocal-convex unstable resonator.

23. The system of claim 1, wherein said unstable resonator is an unstable ring resonator.

24. A method for coherent beam combination comprising the steps of:
producing a first electromagnetic field from a first gain medium;
producing a second electromagnetic field from a second gain medium;
expanding said first and said second electromagnetic fields in an unstable resonator having a magnification factor; and
coherently combining said expanded first electromagnetic field with said expanded second electromagnetic field.

25. The method of claim 24, further comprising producing an output beam with an intensity that is proportional to an amplitude product squared, said amplitude product being an amplitude of said first electromagnetic field multiplied by an amplitude of said second electromagnetic field.

26. The method of claim 24, wherein said step of producing a first electromagnetic field further comprises producing signal and idler fields.

27. The method of claim 24, further comprising producing a third electromagnetic field and expanding said third electromagnetic field in said unstable resonator.

28. The method of claim 27, further comprising coherently combining said expanded third electromagnetic field with said expanded first and said second electromagnetic fields.

29. The method of claim 24, further comprising removing heat from said first and said second gain media.
